(19) United States
(12) Patent Application Publication
(10) Pub. No.: US 2012/0217074 A1
(43) Pub. Date: Aug. 30, 2012

(54) All-Electric Powered Vehicle

(76) Inventor: Stephen A. Rudinec, Iron Mountain, MI (US)

(21) Appl. No.: 13/036,554

(22) Filed: Feb. 28, 2011

(51) Int. Cl. B60K 1/04

(52) U.S. Cl. 180/65.1

(57) ABSTRACT

There is provided an all-electric powered vehicle. The all-electric powered vehicle includes a support structure. This support structure defines a portion configured as a tool platform configured to support a tool module. The self-contained battery module is removably mounted on the support structure. A pair of wheel sets is coupled to the support structure, with each wheel set including two wheels. One wheel of each wheel set is rotably coupled on each side of the support structure. An AC induction motor is mounted on the support structure and is coupled to at least one wheel and the battery module. A motor controller, including a DC/AC inverter is coupled to the AC induction motor and the battery module.

### BACKGROUND OF THE INVENTION

### Field of the Invention

The present disclosure related generally to vehicles, particularly all-electric powered vehicles, and more specifically an all-electric powered vehicle with a tool platform, the vehicle configured for mining and construction environments.

Mining payloads typically are transported through tunnels of underground mines either by a railway train, including a locomotive and one or more cars operated on a fixed system of railway tracks, or by rigid body, load-carrying trucks. Vehicles such as wheel dump trucks are designed for hauling loads over tracks in underground mine tunnels. Such rigid body, load-carrying trucks are typically powered by diesel powered generators or diesel engines. However, diesel powered vehicles are relatively expensive to operate because of fuel costs and expulsion of noxious fumes. Consequently, mine payload hauling vehicles typically are operated by electric power that is supplied to the vehicle via tether cables.

Tethered mining vehicles are commercially available and typically include AC trams used in conjunction with an AC 3-phase power source, operating at approximately 500 volts AC to 1,000 volts AC, with electrical power being supplied to the machine via a power cable. However, the need for powered cables limits the distance that the vehicle can travel as well as the maneuverability of the vehicle. For example, a tethered vehicle must run in a specific route so as not to get crossed up with other cabled vehicles operating in the same mine installation.

In some other mining vehicles, DC motors are used powered by a battery. However, DC motors, because of their construction and operation are subject to carbon tracking and premature failure.

Conventional mining vehicles, typically are used primarily for hauling ore or debris from the mine and are configured for a specific use. If a different type of cargo is to be maneuvered through the mine system, a different vehicle typically is required and utilized. Because such arrangement requires additional vehicles, i.e. one for each type of purpose, equipment costs are very expensive in addition to the comments stated above.

The vehicle of the present disclosure must also be of construction which is both durable and long lasting, and it should also require little or no maintenance to be provided by the user throughout its operating lifetime. In order to enhance the market appeal of the vehicle of the present disclosure, it should also be of cost effective construction to thereby afford it the broadest possible market. Finally, it is also an objective that all of the aforesaid advantages and objectives be achieved without incurring any substantial relative disadvantage.

### SUMMARY OF THE INVENTION

The disadvantages and limitations of the background art discussed above are overcome by the present disclosure.

There is provided an all-electric powered vehicle. The all-electric powered vehicle includes a support structure. The support structure defines a portion configured as a tool platform, with the tool platform configured to couple with a tool module. A self-contained battery module is removably mounted on the support structure.

A pair of wheel sets is coupled to the support structure, with each wheel set including two wheels. One wheel of each wheel set is rotably coupled on each side of the support structure. An AC induction motor is mounted on the support structure and is coupled to at least one wheel and the battery module. A motor controller, including a DC/AC inverter, is coupled to the AC induction motor and the battery module. A vehicle controller is coupled to the motor controller.

The all-electric vehicle can be configured with the battery module receiving and storing electrical power generated by the braking function of the vehicle onto the inverter by the AC induction motor to dissipate mechanical energy wherein the mechanical energy is provided by the at least one wheel turning the AC induction motor. The tool platform portion of the support structure can have a tool coupled to the tool platform such as a crane, a boom, a tank, a tilt-bed, a lift apparatus, and/or a personnel seat.

There is provided an all-electric powered vehicle. The all-electric powered vehicle includes a support structure. The support structure includes a portion configured as a tool platform, with the support structure configured to move within an underground mine. The tool platform is configured to couple with a tool module. The self-contained battery module is removably mounted on the support structure. A pair of wheels is coupled to the support structure, with each wheel set including two wheels. One wheel of each wheel set is rotably coupled on each side of the support structure. An AC induction motor is mounted on the support structure and is coupled to the battery module. The AC induction motor is operably coupled to a force transfer apparatus, with the force transfer apparatus coupled to a motor operably coupled to each wheel. A motor controller, including a DC/AC inverter, is coupled to the AC induction motor and the battery module. The motor coupled to each wheel can be one of an electric motor and a hydraulic motor.

There is further provided an all-electric powered vehicle. The all-electric powered vehicle includes a support structure defining a portion configured as a tool platform which is configured to couple with a tool module. This support structure is configured to move within an underground mine. The self-contained battery module is removably mounted on the support structure. A pair of wheel sets are coupled to the support structure, with each wheel set including two wheels. One wheel of each wheel set is rotably coupled on each side of the support structure. An AC induction motor is coupled to the battery module and operably coupled to each wheel. A motor controller, including a DC/AC inverter, is coupled to each AC induction motor and the battery module.

The vehicle of the present disclosure is of a construction which is both durable and long lasting, and which will require little or no maintenance to be provided by the user throughout its operating lifetime. The vehicle of the present disclosure is also of cost effective construction to enhance its market appeal and to thereby afford it the broadest possible market. Finally, all of the aforesaid advantages and objectives are achieved without incurring any substantial relative disadvantage.

### DESCRIPTION OF THE DRAWINGS

These and other advantages of the present disclosure are best understood with reference to the drawings, in which:

FIG. 1 is a plan side view of an exemplary embodiment of an all-electric powered vehicle.

FIG. 2 is a perspective view of the vehicle illustrated in FIG. 1 without the cargo bed or front hood and including additional roll bars.

FIG. 3 is a perspective view of the vehicle illustrated in FIG. 1 without body panels.

FIG. 4 is a perspective front view of the motor compartment of the vehicle illustrated in FIG. 1.

FIG. 5 is a partial plan of the rear end of an exemplary embodiment of an all-electric vehicle including a motor coupled to each wheel.

FIG. 6 is a schematic block diagram of an all-electric powered vehicle including a mechanical force transfer system.

FIG. 7 is a schematic block diagram of an all-electric powered vehicle including a hydrostatic drive system.

FIG. 8 is a schematic block diagram of an all-electric powered vehicle including an electric motor coupled to each wheel of each wheel set.

FIG. 9 is a schematic block diagram of an all-electric powered vehicle including a system including a hydrostatic drive and a mechanical force transfer system configured for fulltime rear wheel drive and front wheel on-demand drive.

FIGS. 10A-10F are side views of the vehicle illustrated in FIG. 1 with the tool platform portion of the support structure configured with exemplary embodiments of different tool modules coupled to the tool platform.

FIG. 11 is a schematic diagram of an exemplary embodiment of a vehicle controller including a motor control for the vehicle illustrated in FIG. 1.

### DETAILED DESCRIPTION OF THE EXEMPLARY EMBODIMENTS

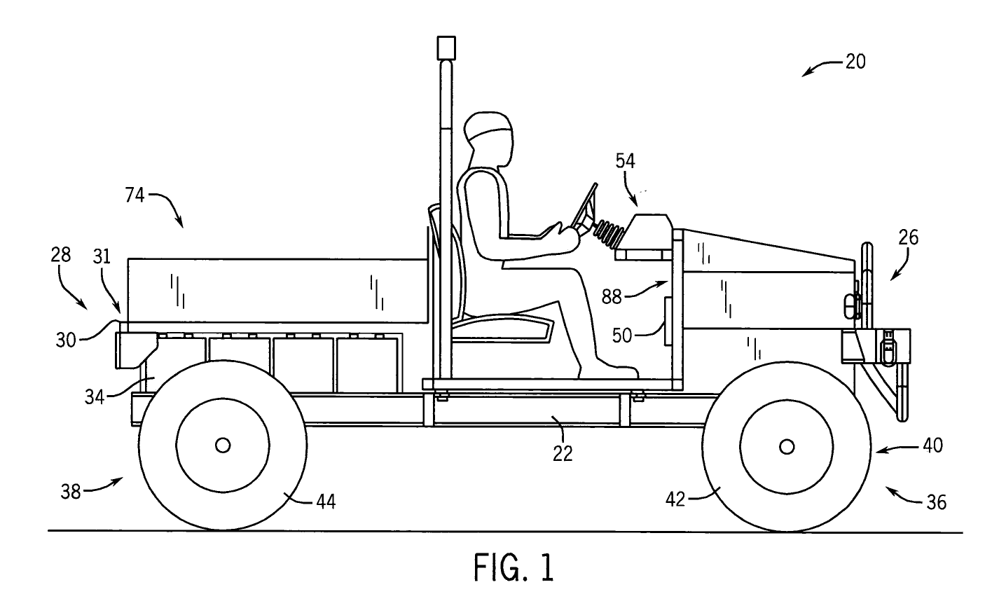

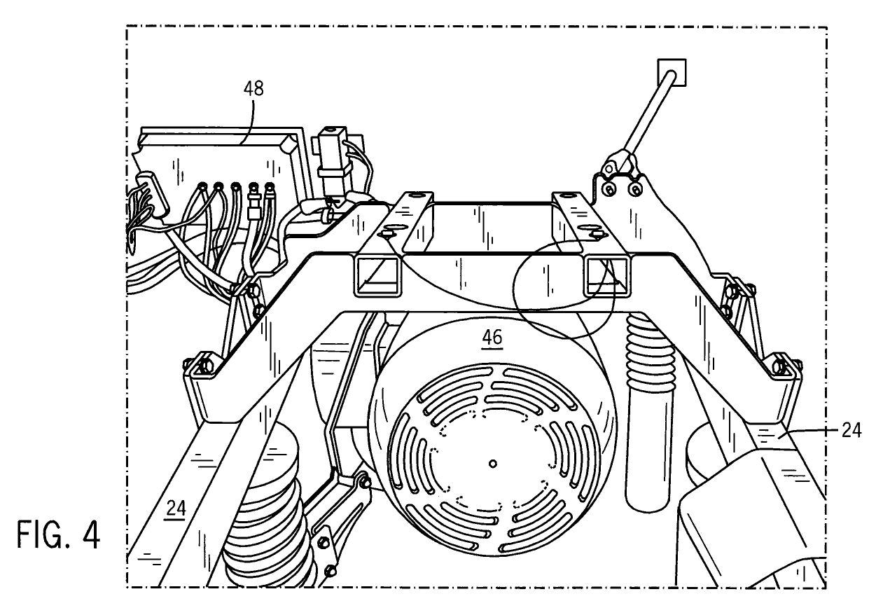

Referring to the FIGS. 1-11, FIG. 1 is a side view of an exemplary embodiment of an all-electric powered vehicle 20 that includes a tool platform 31 configured to couple to a tool module 32. The all-electric powered vehicle 20 is configurable with various tool modules 32 utilizing the same support structure 22 and motive force, an AC induction motor 46.

The all-electric powered vehicle 20 includes a support structure 22 having a portion 30 configured as a tool platform 31. The tool platform 31 is configured to couple with a tool module 32. The tool module 32, for a specific operation, is selected from a group consisting of a crane 78, a boom 82, a tank 76, a tilt-bed 80, a lift apparatus 84, a scissor lift 86, a crew cab 70, and a personnel seat 72. The tool module is coupled to the tool platform portion 31 of the support structure 22.

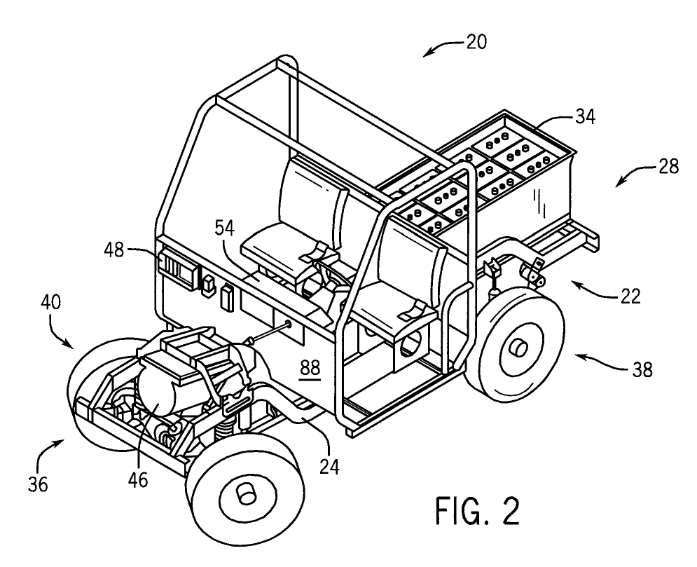

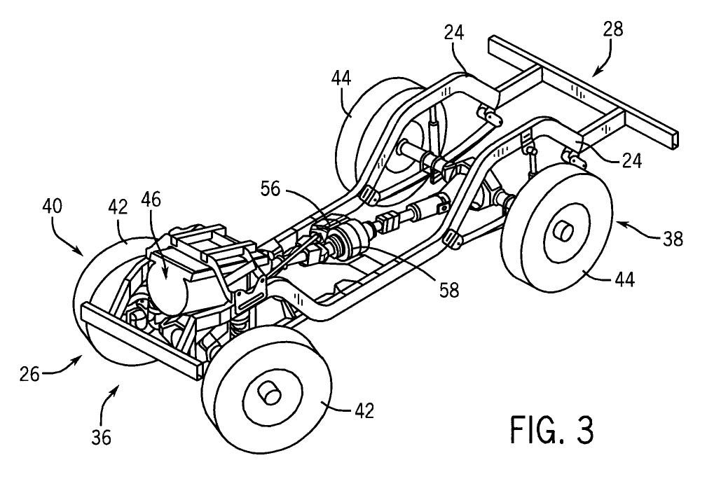

FIGS. 2 and 3 are an illustration of an all-electric vehicle without some body panels. The support structure 22 includes a pair of side support structures 24 which typically are configured metal channels aligned parallel to each other in a spaced-apart relationship. The side support structures 24 define a front of the vehicle 26 and a back of the vehicle 28. Various components of the all-electric powered vehicle 20 are coupled to the support structure 22 such as the battery module 34, a pair of wheel sets 36 and 38 with each wheel set 36, 38 having two wheels 42, 44. In one embodiment, the vehicle front 26 has a wheel set 36 configured as a steerable wheel set 40 for maneuvering the powered vehicle 20. It is also contemplated that the other wheel set 38 which typically is in the back of the vehicle 28 can also be steerable in coordination with the front wheel set 36. It should also be understood that additional wheel sets can be coupled to the support structure 22 as determined by the user and/or manufacturer which is dependant on the type of load and the maneuvering capabilities are required for the vehicle 20.

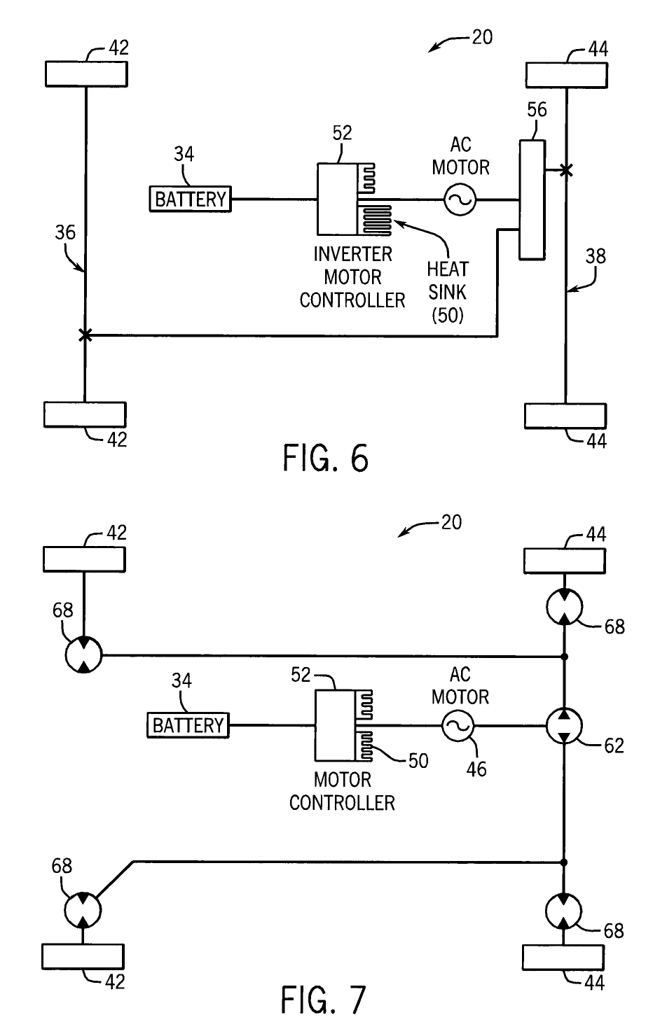

The all-electric powered vehicle 20 is powered by an AC induction motor 46 which is mounted on the support structure 22 and coupled to at least one wheel and the battery module 34. As illustrated in FIGS. 2, 3, and 4, the AC induction motor 46 is coupled to the support structure 22 typically at the front 26 of the vehicle 20. In one embodiment, the AC induction motor 46 is a 15 hp continuous duty rated AC induction motor. The motor is capable of delivering 25 hp for 30 minutes, however, larger or smaller motor options are typically available depending on the use conditions. It should be understood that the electrical and mechanical ratings of the AC motor 46 can be suitable for a particular application and venue. The AC motor drives a force transfer apparatus 56. In FIG. 3, the force transfer apparatus 56 is a gear box 58 which is coupled to mechanical front and rear axels to provide either two or four wheel drive for the vehicle 20. FIG. 6 also illustrates a schematic block diagram of an all-electric powered vehicle 20 including a mechanical force transfer system.

The electrical energy for the all-electric powered vehicle 20 is supplied by a battery module 34 which is replaceable. As illustrated in FIGS. 1 and 2, in one embodiment of the all-electric powered vehicle 20 the battery module 34 is coupled to the support structure 22 below the portion 30 of the support structure 22 that constitutes the tool platform 31. The replaceable battery pack module 34, in one embodiment is a series of absorbed glass mat batteries. However, a lead acid battery or lithium ion battery can be used to power the vehicle 20. In operation, the self-contained battery module 34 is removable for charging. The fully charged battery module can be installed in the vehicle 20 to replace a depleted battery module so that the vehicle can continue in its designated operations. It is also contemplated that the battery module 34 can be recharged while it is installed on the vehicle, as well as by a regenerative operation described below.

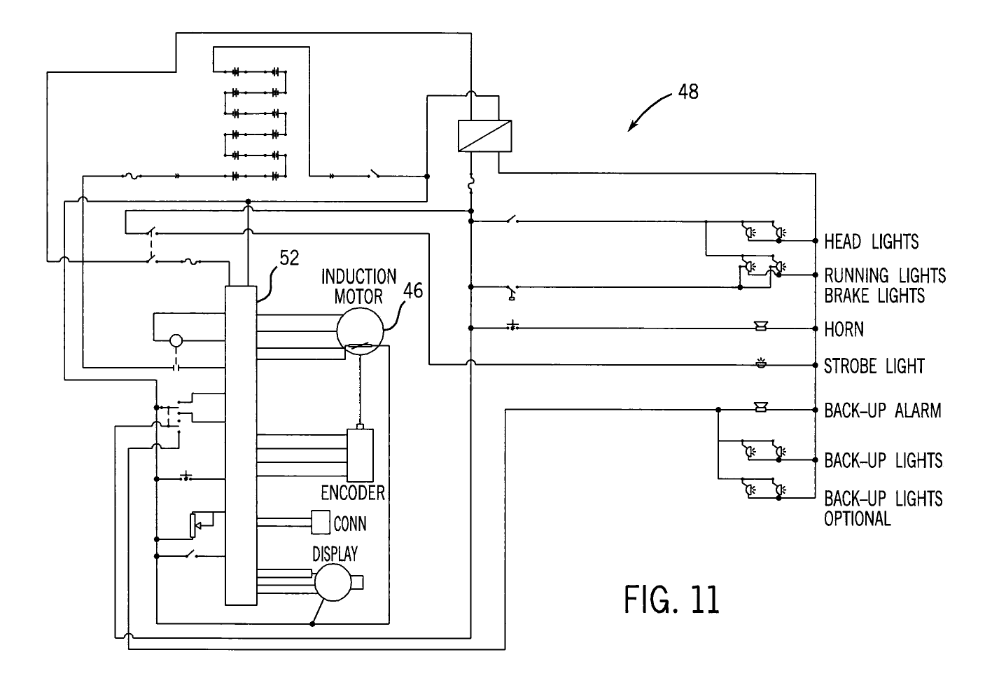

The all-electric powered vehicle 20 includes a motor controller 48 having a DC/AC inverter 52 coupled to the AC induction motor 46 and the battery module 34. See FIGS. 6-9 which illustrates various configurations of the power system for the vehicle 20. FIG. 11 is a schematic diagram of an exemplary embodiment of a vehicle controller 54 including a motor control for the vehicle 20. The motor controller 48 in conjunction with the vehicle controller 54 controls and operates the various functions on the all-electric powered vehicle 20 as illustrated in the schematic of FIG. 11.

The battery module 34 typically is a 72-volt DC configuration that through the DC to AC inverter 52 delivers 45 volts AC to the induction motor 46. The battery module 34 can also be configured to provide a voltage in the range of 48 to 240 volts DC depending on the required horsepower for the vehicle as determined by the user or manufacturer.

Various sensors, such as a speed bearing sensor or encoder are coupled to the AC motor to provide speed references back to the motor controller 48 to operate the vehicle 20 as needed. The vehicle controller 54 typically includes digital graphic displays that indicate batter life remaining, speed of the vehicle, and other related information useful to an operator, as well as steering and throttle controls.

Because of the heat generated by the conversion of DC electrical energy to AC electrical energy in the inverter 52, a heat sink 50 is mounted directly on the motor controller 48. In one embodiment the motor controller is mounted on the motor 46 side of the firewall 88 and the heat sink is coupled to the motor controller 48, but positioned on the driver side of the firewall 88. In another embodiment, the motor controller 48 is mounted on the driver side of the firewall 88 and the heat sink 50 is on the motor side of the firewall 88, but directly coupled to the motor controller. The motor controller 48 and heat sink 50 are coupled to the vehicle 20 at a convenient location, for example, on either side of the dash board which separates the operator position from the induction motor 46 location. The motor controller 48 and the mounted heat sink 50 can be mounted at any other convenient and appropriate location on the vehicle 20.

As illustrated in FIGS. 7-9, various drive configurations can be implemented in the disclosed all-electric vehicle 20. FIG. 7 illustrates a schematic block diagram of an all-electric powered vehicle 20 including a hydrostatic drive system including a hydraulic pump 62 coupled to the AC induction motor 46. The hydraulic pump 62 powers individual hydraulic motors 68 coupled to each wheel 42, 44 of the wheel sets 36, 38 of the vehicle 20. Appropriate conduit and valving trains are utilized to control the movement of the vehicle, for example in either two or four wheel drive configurations.

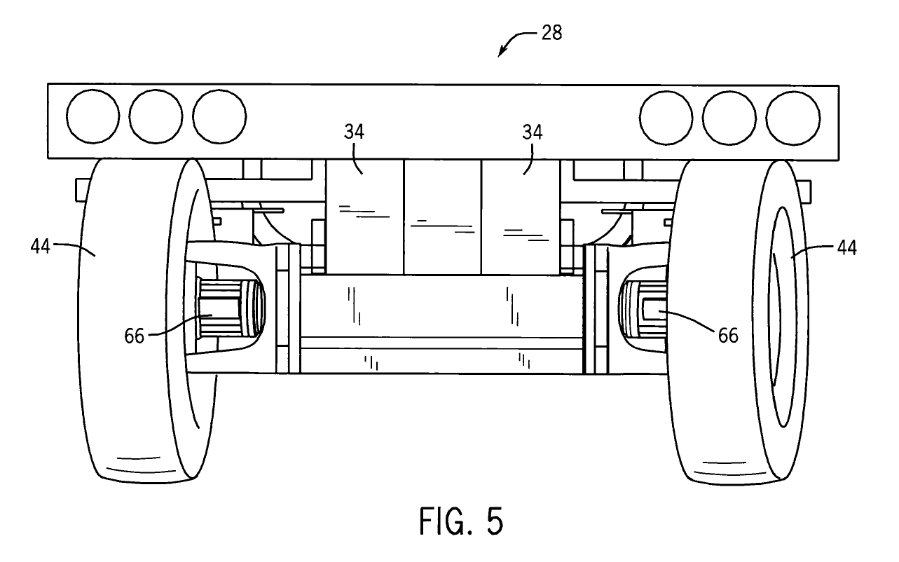

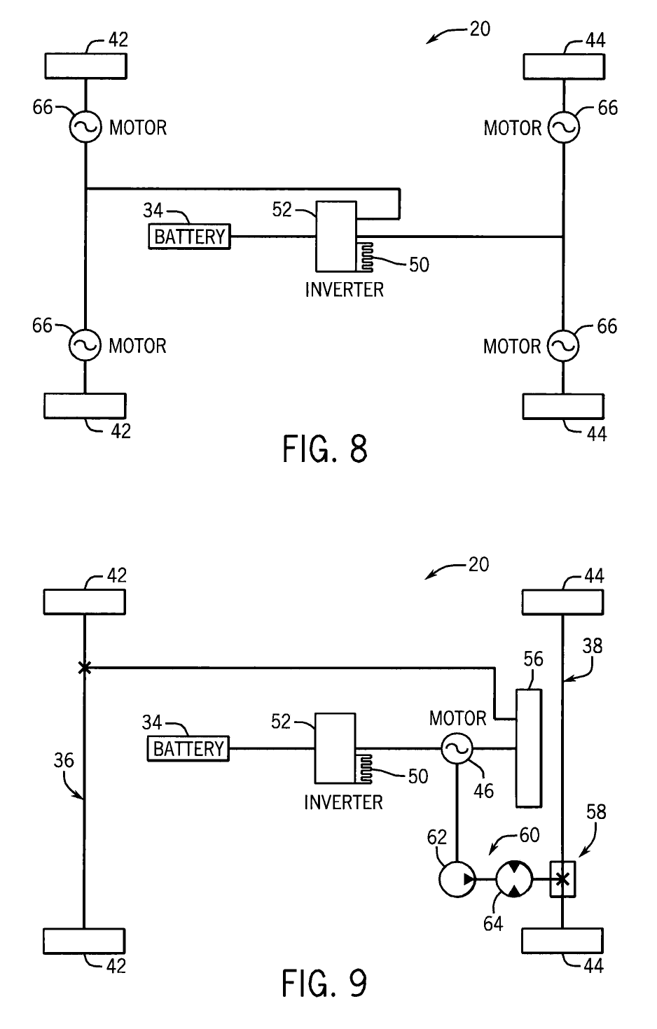

FIG. 8 illustrates a schematic block diagram of an all-electric powered vehicle 20 including an electric motor 66 coupled to each wheel 42, 44 of each wheel set 36, 38. (See also FIG. 5) Each of the electric motors 66, through appropriate control wiring, provides selected power to each wheel, for example providing two and four wheel drive capability for the all-electric vehicle 20.

FIG. 9 is a schematic block diagram of a all-electric powered vehicle 20 including a power system including a hydrostatic drive composed of hydraulic pump and motor set 60 and a mechanical force transfer system including a force transfer apparatus 56 configured for full-time rear wheel drive and front wheel-on-demand drive. The hydraulic pump motor set 60 includes a hydraulic pump 62 and a hydraulic motor 64. With the hydraulic motor 64 coupled to an appropriate gear box 58 coupled to the wheel set 44 of the wheel set 38. A selective control of either the rear wheel drive or front wheel-on-demand drive is controlled through the vehicle controller 54 selected by the operator of the vehicle 20.

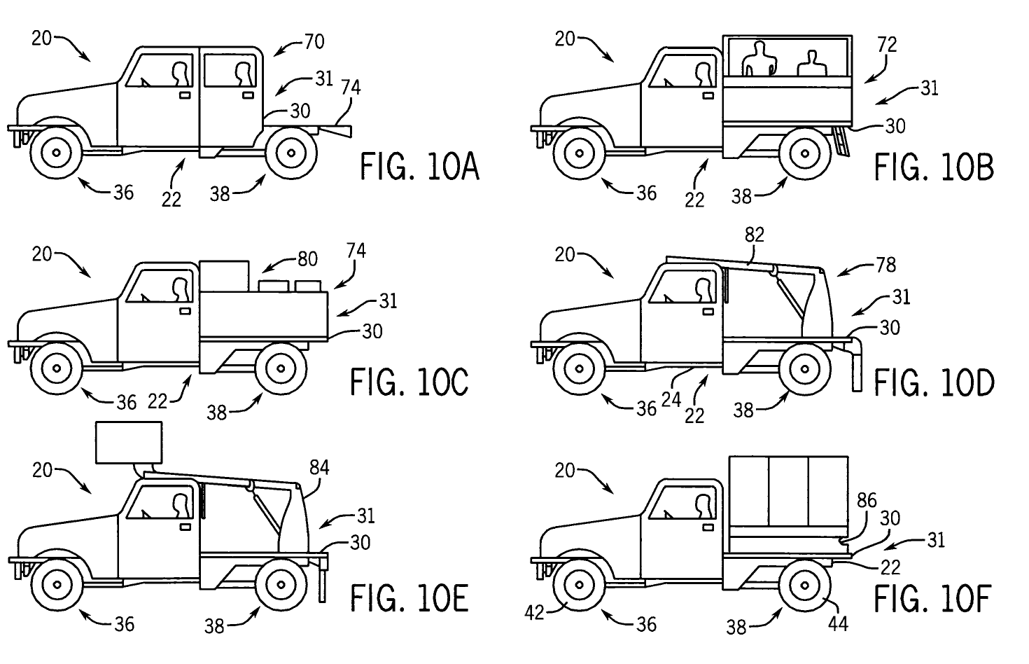

One of the advantages of the disclosed all-electric powered vehicle 20 is it is reconfigurable for different operations and capabilities with the support structure 22 including a portion 30 configured as a tool platform 31. The all-electric vehicle 20, is suitable for operation in and about mine sites, including underground operations. The all-electric vehicle 20 is also suitable for operation in and around construction sites. The tool platform is configured to couple with a tool module 32. FIGS. 10A-10F illustrate exemplary embodiments of the all-electric vehicle 20 with different tool modules 32 coupled to the tool platform 31 of the vehicle.

FIG. 10A illustrates the vehicle 20 with the tool platform 31 configured with a crew cab 70 and a cargo bed 74.

FIG. 10B illustrates the vehicle 20 with the tool platform 31 configured with personnel seats 72.

FIG. 10C illustrates the vehicle 20 with the tool platform 31 configured with the cargo bed 74 having a tilt bed 80.

FIG. 10D illustrates an all-electric vehicle 20 with the tool platform 31 configured with a crane having a boom 82. The crane and boom includes actuators, for example hydraulic cylinders or electric motors controlled by the vehicle controller 54 and powered by the battery module 34.

FIG. 10E illustrates the vehicle 20 with the tool platform 31 configured with a lift apparatus 84. The lift apparatus 84 illustrated in FIG. 9E includes a personnel carrier so that an operator can be lifting to a selected height as determined by the operator. Appropriate actuators, for example electric motors or hydraulic cylinders and pumps are used to articulate the lift apparatus 84.

FIG. 10F illustrates the vehicle 20 with the tool platform 31 configured with a scissor type lift apparatus 86 that can be used to lift personnel or cargo to a selected height as determined by an operator. The lift apparatus 86 includes actuators, for example electric motors or hydraulic cylinders and pumps to control and articulate the lift apparatus at selected heights as determined by the operator.

The all-electric vehicle 20 is also configured with the battery module 34 configured to receive and store electrical power regenerated through the inverter 52 by the AC induction motor 46 functioning as a generator to dissipate mechanical energy from the wheels 42, 44 in order to provide a braking function to the vehicle. The regenerative braking function of the vehicle, in addition to controlling the deceleration of the vehicle, can also be configured to recharge the batteries in the battery module 34. For example if the vehicle 20 is moving in a down-hill aspect as is typically found in mining venues the operator of the vehicle 20 can utilize the AC induction motor 46 to slow the vehicle. In one arrangement, the operator switches the AC induction motor 46 from an electric motor to an electric generator with the electric motor 46 being turned by the motion of the vehicle wheels 42, 44 rotating the electric motor through appropriate couplings. Such configuration slows the vehicle 20 down and also regenerates the battery module 34.

One advantage of the all-electric powered vehicle 20 of the present disclosure is that it is emission free and generates no exhaust as is typically found in diesel-powered mining vehicles. The AC induction motor 46 provides high torque at a reasonable rpm without the need to rev up and emit large amounts of exhaust as is typical in a diesel-powered vehicle. The DC/AC inverter 52 provides the induction motor 46 with the proper voltage and frequency to achieve a desired speed. Since the AC induction motor has no brushes, there is no carbon deterioration or carbon issues as is typical with a DC electric motor. The preferred battery module 34 is one that includes the absorbed glass mat-type battery since such battery is classified as “non-spillable” and can be shipped as non-hazardous material. Further such absorbed glass mat batteries are maintenance free.

For purposes of this disclosure, the term “coupled” means the joining of two components (electrical or mechanical) directly or indirectly to one another. Such joining may be stationary in nature or moveable in nature. Such joining may be achieved with the two components (electrical or mechanical) and any additional intermediate members being integrally formed as a single unitary body with one another or the two components and any additional member being attached to one another. Such adjoining may be permanent in nature or alternatively be removable or releasable in nature.

Although the foregoing description of the present disclosure has been shown and described with reference to particular embodiments and applications thereof, it has been presented for purposes of illustration and description and is not intended to be exhaustive or to limit the vehicle to the particular embodiments and applications disclosed. It will be apparent to those having ordinary skill in the art that a number of changes, modifications, variations, or alterations to the vehicle as described herein may be made, none of which depart from the spirit or scope of the present disclosure. The particular embodiments and applications were chosen and described to provide the best illustration of the principles of the vehicle and its practical application to thereby enable one of ordinary skill in the art to utilize the disclosure in various embodiments and with various modifications as are suited to the particular use contemplated. All such changes, modifications, variations, and alterations should therefore be seen as being within the scope of the present disclosure as determined by the appended claims when interpreted in accordance with the breadth to which they are fairly, legally, and equitably entitled.

What is claimed is:

1. An all-electric powered vehicle comprising:
a support structure including a portion configured as a tool platform and the tool platform is configured to couple with a tool module;
a self-contained battery module removably mounted on the support structure;
a pair of wheel sets coupled to the support structure, with each wheel set including two wheels, with one wheel of each wheel set rotably coupled on each side of the support structure;
an AC induction motor mounted on the support structure and coupled to at least one wheel and the battery module;
a motor controller including a DC/AC inverter coupled to the AC induction motor and the battery module; and
a vehicle controller coupled to the motor controller.

2. The all-electric vehicle of claim 1, including a heat sink mounted on the motor controller.

3. The all-electric vehicle of claim 1, wherein one of the wheel sets is steerable.

4. The all-electric vehicle of claim 1, including a force transfer apparatus coupled to the AC induction motor and at least one of wheels of one of the wheel sets.

5. The all-electric vehicle of claim 4, wherein the force transfer apparatus is coupled to another wheel set, with the transfer case configured to drive one of either wheel sets and both wheel sets at the same time.

6. The all-electric vehicle of claim 4, wherein the force transfer apparatus is one of a gear box and a hydraulic pump/hydraulic motor set.

7. The all-electric vehicle of claim 1, wherein the battery module is configured to receive and store electrical power generated by the braking function of the vehicle onto the inverter by the AC induction motor to dissipate mechanical energy, wherein the mechanical energy is provided by the at least one wheel turning the AC induction motor.

8. The all-electric powered vehicle of claim 1 further comprising a tool module selected from a group consisting of a crane, a boom, a tank, a tilt-bed, a lift apparatus, a crew cab, and a personnel seat, with the tool coupled to the tool platform portion of the support structure.

9. An all-electric powered vehicle comprising:
a support structure including a portion configured as a tool platform, with the support structure configured to move within an underground mine and with the tool platform configured to couple with a tool module;
a self-contained battery module removably mounted on the support structure;
a pair of wheel sets coupled to the support structure, with each wheel set including two wheels, with one wheel of each wheel set rotably coupled on each side of the support structure;
an AC induction motor mounted on the support structure and coupled to the battery module and operably coupled to a force transfer apparatus, with the force transfer apparatus coupled to a motor operably coupled to each wheel; and
a motor controller including a DC/AC inverter coupled to the AC induction motor and the battery module.

10. The all-electric powered vehicle of claim 9, wherein the motor coupled to each wheel is one of an electric motor and a hydraulic motor.

11. The all-electric powered vehicle of claim 9, including a heat sink mounted on the motor controller.

12. The all-electric powered vehicle of claim 9, wherein one of the wheel sets is steerable.

13. The all-electric powered vehicle of claim 9, wherein both of the wheel sets are steerable.

14. The all-electric powered vehicle of claim 9, wherein the battery module is configured to receive and store electrical power generated by the braking function of the vehicle into the inverter by the AC induction motor to dissipate mechanical energy, wherein the mechanical energy is provided by the at least one wheel turning the AC induction motor.

15. The all-electric powered vehicle of claim 9, wherein the force transfer apparatus is coupled to another wheel set, with the transfer case configured to drive one of either wheel sets and both wheel sets at the same time.

16. The all-electric powered vehicle of claim 9, further comprising a tool module selected from a group consisting of a crane, a boom, a tank, a tilt-bed, a lift apparatus, and a personnel seat, with the tool coupled to the tool platform portion of the support structure.

17. An all-electric powered vehicle comprising:
a support structure including a portion configured as a tool platform, with the support structure configured to move within an underground mine and with the tool platform configured to couple with a tool module;
a self-contained battery module removably mounted on the support structure;
a pair of wheel sets coupled to the support structure, with each wheel set including two wheels, with one wheel of each wheel set rotably coupled on each side of the support structure;
an AC induction motor coupled to the battery module and operably coupled to each wheel; and
a motor controller including a DC/AC inverter coupled to each AC induction motor and the battery module.

18. The all-electric powered vehicle of claim 17, including a heat sink mounted on the motor controller.

19. The all-electric powered vehicle of claim 17, wherein one of the wheel sets is steerable.

20. The all-electric powered vehicle of claim 17, wherein both of the wheel sets are steerable.

21. The all-electric powered vehicle of claim 17, wherein the battery module is configured to receive and store electrical power generated by the braking function of the vehicle onto the inverter by each of the AC induction motors to dissipate mechanical energy, wherein the mechanical energy is provided by the at least one wheel turning one of the AC induction motors.

22. The all-electric powered vehicle of claim 17, wherein the motor controller is configured to drive one of either wheel sets and both wheel sets at the same time.

23. The all-electric powered vehicle of claim 17, wherein the motor controller is configured to drive one of either wheel sets and both wheel sets at the same time.

24. The all-electric powered vehicle of claim 17, further comprising a tool module selected from a group consisting of a crane, a boom, a tank, a tilt-bed, a lift apparatus. and a personnel seat, with the tool coupled to the tool platform portion of the support structure.
